(19) United States
(12) Patent Application Publication
(10) Pub. No.: US 2021/0274522 A1
(43) Pub. Date: Sep. 2, 2021

(54) METHOD FOR SUPPORTING POWER SAVING MODE IN TDD SP IN WIRELESS LAN SYSTEM, AND WIRELESS TERMINAL USING SAME

(71) Applicant: LG ELECTRONICS INC., Seoul (KR)

(72) Inventors: Saehee BANG, Seoul (KR); Jinmin KIM, Seoul (KR); Kiseon RYU, Seoul (KR); Jinsoo CHOI, Seoul (KR)

(73) Assignee: LG ELECTRONICS INC., Seoul (KR)

(21) Appl. No.: 17/254,259

(22) PCT Filed: Apr. 22, 2019
(86) PCT No.: PCT/KR2019/004809

§ 371 Date: Dec. 18, 2020

(30) Foreign Application Priority Data
Jun. 22, 2018 (KR) 10-2018-0072390
Jul. 4, 2018 (KR) 10-2018-0077936

(51) Int. Cl. H04W 72/12; H04W 72/04; H04L 5/14; H04W 52/02

(52) U.S. Cl. CPC H04W 72/1263; H04W 72/1257; H04W 84/12; H04L 5/1469; H04W 52/0206; H04W 72/0446

(57) ABSTRACT

This method for supporting a power saving mode in a TDD SP executed in a wireless LAN system by a first wireless terminal includes: a step for receiving TDD slot schedule elements from a second wireless terminal, wherein the TDD slot schedule elements include first information used for permitting a PS mode to the first wireless terminal, and second information associated with a slot schedule start time for the first wireless terminal; a step for switching to a doze state associated with the PS mode on the basis of the first information, after the TDD slot schedule elements are received by the first wireless terminal; a step for maintaining, on the basis of the second information, the doze state until the slot schedule start time is reached; and a step for switching from the doze state to an awake state associated with the PS mode upon reaching the slot schedule start time.

### BACKGROUND

### Field

The present disclosure relates to wireless communication, and more particularly, to a method for supporting a power saving mode in a time division duplex service period (TDD SP) in a wireless local area network (WLAN) system, and a wireless terminal using the same.

### Related Art

Institute of Electrical and Electronics Engineers (IEEE) 802.11ad standard is an ultra-high speed wireless communication standard which is operating in a band of 60 GHz or more. The coverage range of signal is about 10 meters, but throughput of 6 Gbps or more can be supported. Since it operates in a high frequency band, a signal propagation such as ray-like propagation is dominate. A signal quality is improved as a transmit (TX) or receive (RX) antenna beam is arranged so as to head on a strong spatial signal path.

IEEE 802.11ad standard provides a beamforming training procedure for antenna beam arrangement. IEEE 802.11ay is a next generation standard which has been developed targeted to throughput of 20 Gbps or more.

### SUMMARY

The present disclosure provides a method for supporting a power saving mode in a time division duplex service period (TDD SP) in a wireless local area network (WLAN) system and a wireless terminal using the same to improve performance in terms of power management of a wireless terminal.

In an aspect, a method for supporting a power saving mode in a time division duplex service period (TDD SP) performed by a first wireless terminal in a wireless local area network (WLAN) system includes: receiving a TDD slot schedule element from a second wireless terminal, the TDD slot schedule element including first information used to permit a PS mode to the first wireless terminal and second information associated with a slot schedule start time for the first wireless terminal; switching to a doze state associated with the PS mode based on the first information after the TDD slot schedule element is received by the first wireless terminal; maintaining the doze state until the slot schedule start time elapses based on the second information; and switching the doze state to an awake state associated with the PS mode when the slot schedule start time elapses.

According to an embodiment of the present disclosure, a method for supporting a power saving mode in a TDD SP in a wireless local area network (WLAN) system and a wireless terminal using the same may be provided to improve performance in terms of power management of the wireless terminal.

### BRIEF DESCRIPTION OF THE DRAWINGS

FIG. 1 is a conceptual diagram showing a structure of a wireless local area network (WLAN) system

FIG. 2 is a conceptual diagram of a hierarchical architecture of a wireless local area network (WLAN) system supported by IEEE 802.11.

FIG. 3 is a diagram for describing an access period in a beacon interval.

FIG. 4 is a conceptual diagram illustrating a structure of time division duplex (TDD) SP.

FIG. 5 is a diagram illustrating a format of TDD slot structure element defining TDD SP structure.

FIG. 6 is a diagram illustrating a format of the slot structure control field for the TDD slot structure element.

FIG. 7 is a diagram illustrating a format of a slot structure field of the TDD slot structure element.

FIG. 8 a diagram illustrating a format of the TDD slot structure element defining a schedule for a TDD channel access.

FIG. 9 is a diagram illustrating a format of a control field of a TDD slot schedule element.

FIG. 10 is a diagram illustrating an operation of a wireless terminal supporting a power saving mode in a TDD SP in a wireless local area network (WLAN) system according to an embodiment of the present disclosure.

FIG. 11 is a diagram embodying an operation of a wireless terminal supporting a power saving mode in a TDD SP in a wireless local area network (WLAN) system according to an embodiment of the present disclosure.

FIG. 12 is a flowchart illustrating a method of supporting a power saving mode in a TDD SP in a wireless local area network (WLAN) system according to an embodiment of the present disclosure from an STA perspective.

FIG. 13 is a flowchart illustrating a method of supporting a power saving mode in a TDD SP in a wireless local area network (WLAN) system according to an embodiment of the present disclosure from an AP perspective.

FIG. 14 is a block diagram illustrating a wireless device to which the embodiment may be applied.

FIG. 15 is a block diagram illustrating an example of a device included in a processor

### DESCRIPTION OF EXEMPLARY EMBODIMENTS

The above-described features and detailed description below are illustrated to aid in description and understanding of the disclosure. That is, the disclosure is not limited to such embodiments and may be embodied in different forms. The following embodiments are examples for thorough disclosure and explanation for delivering the disclosure to those skilled in the art. Therefore, when there are many methods for implementing components of the disclosure, it is necessary to make it clear that the disclosure can be realized through any of a specific one of these methods and a similar one.

When a certain component includes specific elements or a certain process includes specific steps in the disclosure, other elements or other steps may be further included. That is, the terms used in the disclosure are merely for describing particular embodiments, and are not intended to limit the scope of the disclosure. Furthermore, examples described for aiding in understanding of the disclosure include complementary embodiments thereof.

All terms including technical or scientific terms have the same meanings as generally understood by a person having ordinary skill in the art to which the disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner. Hereinafter, embodiments of the disclosure will be described with reference to the attached drawings.

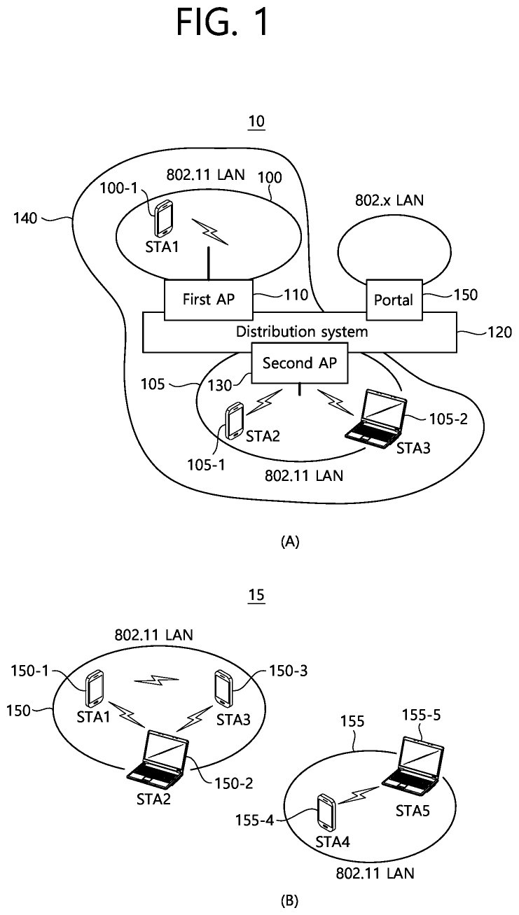

FIG. 1 is a conceptual diagram showing a structure of a wireless local area network (WLAN) system. FIG. 1(A) shows a structure of an infrastructure network of IEEE (Institute of Electrical and Electronic engineers) 802.11.

Referring to FIG. 1(A), the wireless system 10 shown in FIG. 1(a) may include at least one basic service set (BSS) 100 and 105. A BSS is a set of an access point (AP) and a station (STA) which can communication each other in successful synchronization with each other and does not refer to a specific area.

For example, a first BSS 100 may include a first AP 110 and a single first STA 100-1. A second BSS 105 may include a second AP 130 and one or more STAs 105-1 and 105-2.

The infrastructure BSSs 100 and 105 may include at least one STA, APs providing a distribution service, and a distribution system (DS) 120 which connects the APs.

The distribution system 120 can realize an extended service set (ESS) 140 by connecting the plurality of BSSs 100 and 105. The ESS 140 can be used as a term indicating a network realized by connecting one or more APs 110 and 130 through the distribution system 120. One or more APs included in the single ESS 140 may have the same service set identifier (SSID).

A portal 150 can serve as a bridge for connecting the wireless LAN network (IEEE 802.11) to another network (E.g., 802.X).

In the wireless local area network (WLAN) system having the structure shown in FIG. 1(A), a network between the APs 110 and 130 and a network between the APs 110 and 130 and the STAs 100-1, 105-1 and 105-2 can be realized.

FIG. 1(B) is a conceptual diagram showing an independent BSS. Referring to FIG. 1(B), a wireless local area network (WLAN) system 15 shown in FIG. 1(B) can establish a network between STAs without the APs 110 and 130 such that the STAs can perform communication, distinguished from the wireless local area network (WLAN) system of FIG. 1(A). A network established between STAs without the APs 110 and 130 for communication is defined as an ad-hoc network or an independent basic service set (IBSS).

Referring to FIG. 1(B), the IBSS 15 is a BSS operating in an ad-hoc mode. The IBSS does not have a centralized management entity because an APP is not included therein. Accordingly, STAs 150-1, 150-2, 150-3, 155-4 and 155-5 are managed in a distributed manner in the IBSS 15.

All STAs 150-1, 150-2, 150-3, 155-4 and 155-5 of the IBSS may be configured as mobile STAs and are not allowed to access a distributed system. All STAs of the IBSS constitutes a self-contained network.

An STA mentioned in the disclosure is an arbitrary functional medium including medium access control (MAC) conforming to regulations of IEEE (Institute of Electrical and Electronics Engineers) 802.11 and a physical layer interface with respect to a wireless medium and may be used as a meaning including both an AP and a non-AP station.

The STA mentioned in the disclosure may also be called various terms such as a mobile terminal, a wireless device, a wireless transmit/receive unit (WTRU), a user equipment (UE), a mobile station (MS), a mobile subscriber unit, and a user.

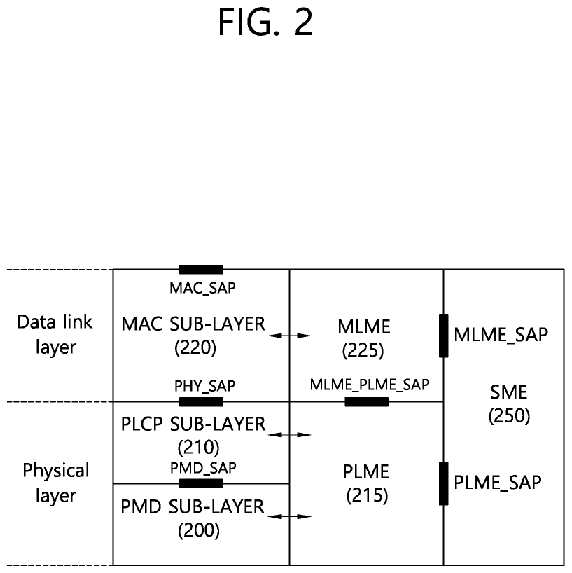

FIG. 2 is a conceptual diagram of a hierarchical architecture of a wireless local area network (WLAN) system supported by IEEE 802.11. Referring to FIG. 2, the hierarchical architecture of the wireless local area network (WLAN) system may include a physical medium dependent (PMD) sublayer 200, a physical layer convergence procedure (PLCP) sublayer 210 and a medium access control (MAC) sublayer 220.

The PMD sublayer 200 can serve as a transport interface for transmitting and receiving data between STAs. The PLCP sublayer 210 is implemented such that the MAC sublayer 220 can operate with minimum dependency on the PMD sublayer 200.

The PMD sublayer 200, the PLCP sublayer 210 and the MAC sublayer 220 may conceptually include a management entity. For example, a manager of the MAC sublayer 220 is called a MAC layer management entity (MLME) 225. A manager of the physical layer is called a PHY layer management entity (PLME) 215.

These managers can provide interfaces for performing layer management operation. For example, the PLME 215 can be connected to the MLME 225 to perform a management operation of the PLCP sublayer 210 and the PMD sublayer 200. The MLME 225 can be connected to the PLME 215 to perform a management operation of the MAC sublayer 220.

To perform correct MAC layer operation, an STA management entity (SME) 250 may be provided. The SME 250 can be operated as an independent component in each layer. The PLME 215, the MLME 225 and the SME 250 can transmit and receive information based on primitive.

The operation in each sublayer will be briefly described below. For example, the PLCP sublayer 210 transfers a MAC protocol data unit (MPDU) received from the MAC sublayer 220 to the PMD sublayer 200 or transfers a frame from the PMD sublayer 200 to the MAC sublayer 220 between the MAC sublayer 220 and the PMD sublayer 200 according to an instruction of the MAC layer.

The PMD sublayer 200 is a sublayer of PLCP and can perform data transmission and reception between STAs through a wireless medium. An MPDU transferred from the MAC sublayer 220 is referred to as a physical service data unit (PSDU) in the PLCP sublayer 210. Although the MPDU is similar to the PSDU, an individual MPDU may differ from an individual PSDU when an aggregated MPDU corresponding to an aggregation of a plurality of MPDU is transferred.

The PLCP sublayer 210 attaches an additional field including information necessary for a transceiver of the physical layer to a PSDU in a process of receiving the PSDU from the MAC sublayer 220 and transferring the PSDU to the PMD sublayer 200. Here, the attached field may be a PLCP preamble and a PLCT header attached to the PSDU, tail bits necessary to return a convolution encoder to a zero state, and the like.

The PLCP sublayer 210 attaches the aforementioned field to the PSDU to generate a PLCP protocol data unit (PPDU) and transmits the PPDU to a reception station through the PMD sublayer 200, and the reception station receives the PPDU and acquires information necessary for data restoration from the PLCP preamble and the PLCP header to restore data.

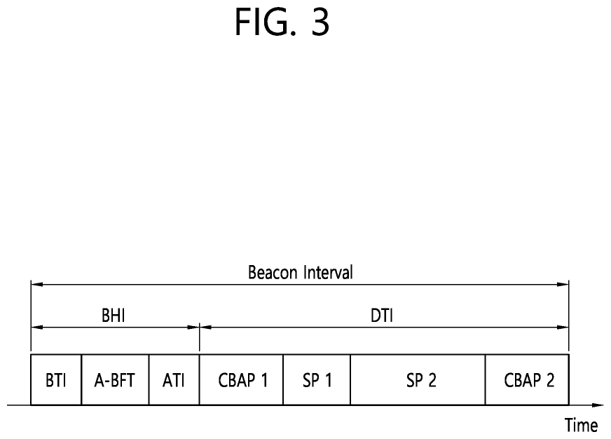

FIG. 3 is a diagram for describing an access period in a beacon interval.

Referring to FIG. 3, a time of a wireless medium may be defined based on a beacon interval between a beacon frame and another beacon frame. For example, a beacon interval may be 1024 milliseconds.

Multiple lower periods in a beacon interval may be disclosed as an access period. Different access periods in a single beacon interval may have different access rules.

For example, information for an access period may be transmitted to a non-AP STA or a non-PCP by an AP or a Personal basic service set Control Point (PCP).

Referring to FIG. 3, a single beacon interval may include a Beacon Header Interval (hereinafter, ‘BHI’) and a Data Transfer Interval (hereinafter, ‘DTI’).

For example, a BHI may be a time period that starts from a target beacon transmission time (hereinafter, ‘TBTT’) and ends before a start of a DTI.

The BHI of FIG. 3 may include a Beacon Transmission Interval (hereinafter, ‘BTI’), an Association Beamforming Training (hereinafter, ‘A-BFT’) and an Announcement Transmission Interval (hereinafter, ‘ATI’).

For example, a BTI may be a time period from a start of a first beacon frame to an end of a last beacon from, which is transmitted by a wireless terminal in a beacon interval. That is, a BTI may be a period during which one or more DMG beacon frame may be transmitted.

For example, an A-BFT may be a period during which a beamforming training is performed by an STA that transmits a DMG beacon frame during a preceding BTI.

For example, an ATI may be a management access period based on request-response between PCP/AP and non-PCP/non-AP STA. The Data Transfer Interval (hereinafter, ‘DTI’) of FIG. 3 may be a period during which a frame is exchanged among multiple STAs.

As shown in FIG. 3, one or more Contention Based Access Period (hereinafter, ‘CBAP’) and one or more Service Period (hereinafter, ‘SP’) may be allocated in a DTI.

A schedule of a DTI of a beacon interval may be communicated through an Extended Schedule element included in a beacon frame (or an announce frame). That is, the Extended Schedule element may include schedule information for defining multiple Allocations included in a beacon interval.

The detailed description for the beacon frame is disclosed through clause 9.4.2.132 of IEEE Draft P802.11-REVmc™/D8.0, August 2016 ‘IEEE Standard for Information Technology Telecommunications and information exchange between systems—Local and metropolitan area networks—Specific requirements Part 11: Wireless LAN Medium Access Control (MAC) and Physical Layer (PHY) Specifications (hereinafter, IEEE 802.11)’ disclosed in August of 2016.

FIG. 3 shows an example that two CBAPs and two SPs are allocated for a single DTI. However, this is just exemplary, and it is understood that the present disclosure is not limited thereto.

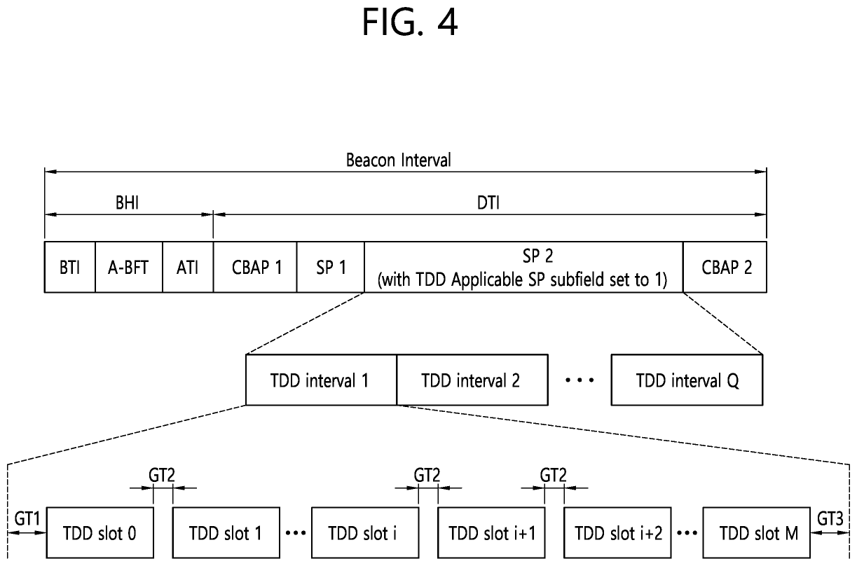

FIG. 4 is a conceptual diagram illustrating a structure of time division duplex (TDD) SP.

Referring to FIG. 1 to FIG. 4, among multiple allocation fields (not shown) included in the Extended Schedule element included in a beacon frame, an allocation field for a second service period SP2 of FIG. 4 may include a first sub-field and a second sub-field.

For example, the first sub-field included in the allocation field for the second service period SP2 of FIG. 4 may be configured with a value indicating SP allocation. In addition, the second sub-field included in the allocation field for the second service period SP2 of FIG. 4 may be configured with a value indicating that the second service period is TDD SP based on TDD channel access.

In the present disclosure, when information for TDD SP is included in the Extended Schedule element, the Extended Schedule element may be included in each beacon frame which is transmitted.

In addition, when the Extended Schedule element is transmitted once or more in a beacon interval, except for a special case, a content of the Extended Schedule element may not be changed.

Referring to FIG. 4, a structure of the second service period SP2 which is TDD SP may include multiple TDD interval 1 to TDD interval Q (Q is a natural number), which is consecutive and adjacent. As an example, the number of multiple TDD intervals of FIG. 4 may be Q.

Furthermore, each of multiple TDD intervals may include one or more TDD slots. For example, a first TDD interval (TDD interval 1) may include M+1 TDD slots (M is a natural number).

For example, a time interval from the start time of the first TDD interval (TDD interval 1) to a time before a start of the first TDD slot (i.e., TDD Slot 0) may be defined as a first guard time (hereinafter, GT1).

For example, a time interval between each of the TDD slots included in the first TDD interval (TDD interval 1) may be defined as a second guard time (GT2).

For example, a time interval from an end time of M+1th TDD slot (TDD slot M) to an end time of the first TDD interval (TDD interval 1) may be defined as a third guard time (GT3).

For example, each of the length of multiple TDD interval (TDD interval 1 to TDD interval Q) may be identical. A length of M+1 TDD slots (e.g., TDD slot 0 to TDD slot M of FIG. 4) included in a single TDD interval (e.g., TDD interval 1 of FIG. 4) may be different.

Referring to FIG. 4, a structure of one or more TDD slots included in the first TDD interval (TDD interval 1) may be repeatedly applied to the remaining TDD intervals (i.e., TDD interval 2 to TDD interval Q).

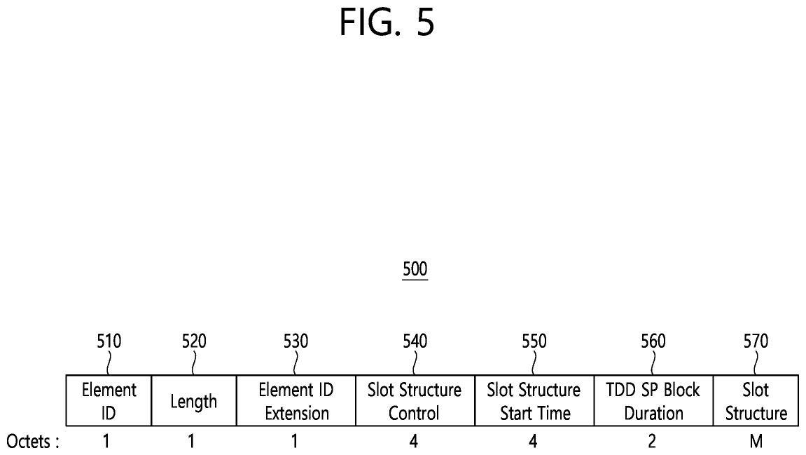

FIG. 5 is a diagram illustrating a format of TDD slot structure element defining TDD SP structure.

A TDD slot structure element 500 of FIG. 5 may define a structure of TDD SP in a beacon interval.

The TDD slot structure element 500 may be included in a beacon frame transmitted periodically by an AP. In this case, the beacon frame may be a frame according to broadcast technique. As an example, the beacon frame may be transmitted in the BTI of FIG. 4.

Referring to FIG. 5, the TDD slot structure element 500 may include multiple fields 510 to 570.

In an element ID field 510 of FIG. 5, a value for distinguishing the TDD slot structure element 500 may be configured.

In a length field 520 of FIG. 5, a value for indicating a length of the TDD slot structure element 500 may be configured.

In an element ID extension field 530 of FIG. 5, a value for distinguishing the TDD slot structure element 500 may be configured together with the element ID field 510.

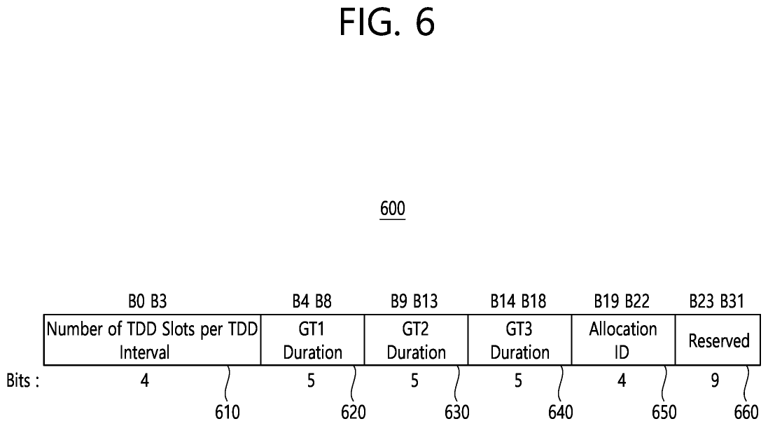

A slot structure control field 540 of FIG. 5 may include additional control information for the TDD slot structure element 500. The slot structure control field 540 of FIG. 5 is described in detail with reference to FIG. 6 that will be described below.

A slot structure start time filed 550 of FIG. 5 may include information corresponding to lower 4 octets of a timing synchronization function (TSF) timer corresponding to a start time of the first TDD SP (e.g., start time of SP2 of FIG. 4) that applies the TDD slot structure element 500.

For example, parameter information for the TDD structure and parameter information for a guard time included in the TDD slot structure element 500 of FIG. 5 may be used for the TDD SP in the beacon interval.

In a TDD SP block duration field 560 of FIG. 5, a value for indicating a duration of a corresponding TDD SP may be configured. For example, the TDD SP block duration field 560 may include information corresponding to a total length of the second service period SP2 of FIG. 4.

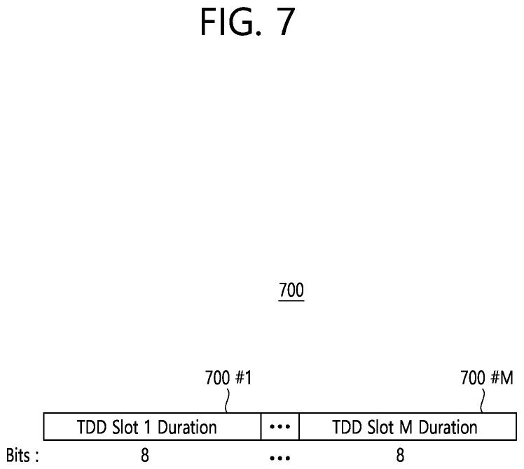

A slot structure filed 570 of FIG. 5 may be a field for defining one or more TDD slots included in each TDD interval. The slot structure field 570 of FIG. 5 is described in detail with referent to FIG. 7 that will be described below.

FIG. 6 is a diagram illustrating a format of the slot structure control field for the TDD slot structure element.

Referring to FIG. 4 to FIG. 6, slot structure control fields 540 and 600 for the TDD slot structure element 500 may include multiple sub-fields 610 to 660.

A sub-field 610 for the number of TDD slots per TDD interval may include information for the number of TDD slots (e.g., M for the case of FIG. 4) included in each TDD interval. In this case, the sub-field 610 for the number of TDD slots per TDD interval may be defined based on 4-bit (B0 to B4).

A GT1 duration sub-field 620 of FIG. 6 may include information for a duration of a first guard time (e.g., GT1 of FIG. 4).

A GT2 duration sub-field 630 of FIG. 6 may include information for a duration of a second guard time (e.g., GT2 of FIG. 4).

A GT3 duration sub-field 640 of FIG. 6 may include information for a duration of a third guard time (e.g., GT3 of FIG. 4).

In an allocation ID sub-field 650 of FIG. 6, information for identifying a TDD SP (e.g., SP2 of FIG. 4) may be configured among the information included in the Extended schedule element that defines a schedule of DTI of a beacon interval. The remaining 9-bit (B23 to B31) of FIG. 6 may be reserved.

FIG. 7 is a diagram illustrating a format of a slot structure field of the TDD slot structure element.

Referring to FIG. 4 to FIG. 7, slot structure fields 570 and 700 for the TDD slot structure element 500 may include first to M^{th} TDD slot duration sub-fields 700#1 to 700#M.

Here, M may correspond to the value included in the sub-field 610 for the number of TDD slots per TDD interval of FIG. 6.

For example, an i^{th} TDD slot duration sub-field (e.g., 1≤i≤M, i and M are natural numbers) may include information for duration of the i^{th} TDD slot in each TDD interval.

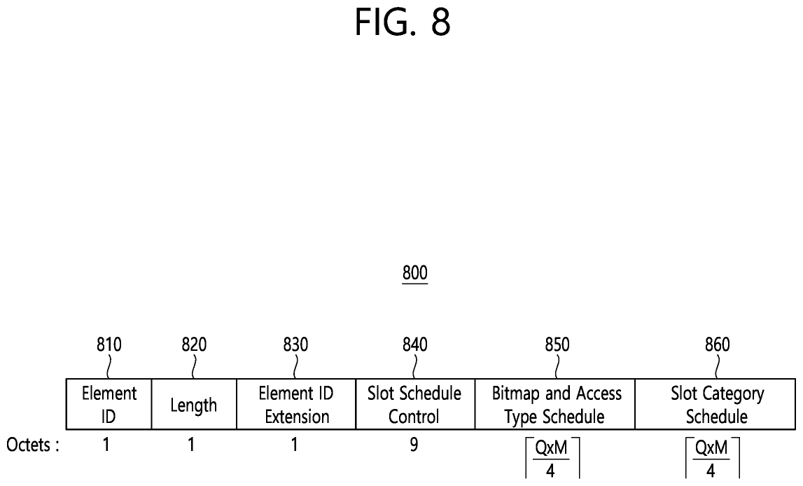

FIG. 8 a diagram illustrating a format of the TDD slot structure element defining a schedule for a TDD channel access.

In the present disclosure, it is understood that the schedule for the TDD channel access may be referred as a TDD schedule.

A TDD slot schedule element 800 may define a schedule (i.e., TDD schedule) for a TDD channel access of a second wireless terminal specified in a TDD SP.

The TDD slot schedule element 800 may be transferred through an announce frame or an association response frame. For example, the announce frame or the association response frame may be a frame according to unicast technique. As an example, the announce frame or the association response frame may be transmitted in the ATI of FIG. 4.

Referring to FIG. 8, the TDD slot schedule element 800 may include multiple fields 810 to 860.

In an element ID field 810 of FIG. 8, a value for distinguishing the TDD slot schedule element 800 may be configured.

In a length field 820 of FIG. 8, a value for indicating a length of the TDD slot schedule element 800 may be configured.

In an element ID extension field 830 of FIG. 8, a value for identifying the TDD slot schedule element 800 may be configured with the element ID field 810.

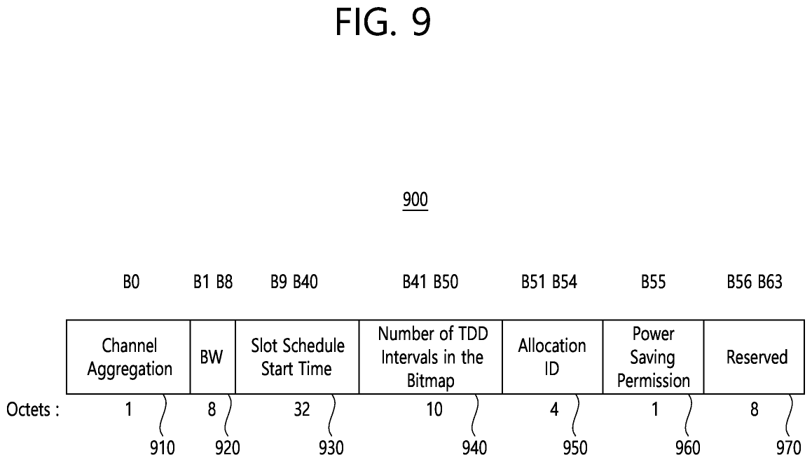

A slot schedule control field 840 of FIG. 8 may include additional control information for the TDD slot schedule element 800. The slot schedule control field 840 of FIG. 8 is described in detail with reference to FIG. 9 that will be described below.

A bitmap and access type schedule field 850 of FIG. 8 may be associated with operation type information permitted in each of the multiple TDD slots included in at least one TDD interval for a wireless terminal that receives the TDD slot schedule element 800.

Here, the bitmap and access type schedule field 850 of FIG. 8 may be bitmap information having a length which is determined based on Equation 1 below.

$$⌈ \frac{Q \times M}{4} ] \qquad [ Equation 1 ]$$

Herein, a length of the bitmap and access type schedule field 850 of FIG. 8 may be understood as a value of rounding up the multiplication of Q and M divided by 4.

As an example, Q of Equation 1 may be understood as the number of at least one TDD intervals after a start time when the TDD slot schedule element 800 for a wireless terminal is applied in a TDD SP.

As an example, M of Equation 1 may be understood as the number of at least one TDD slots included in each of the multiple TDD intervals of FIG. 4.

For example, each of the multiple TDD slots included in at least one TDD interval during which the TDD slot schedule element 800 is applied may correspond to each pair of consecutive 2 bits included in the bitmap and access type schedule field 850 of FIG. 8 sequentially.

Particularly, each pair of consecutive 2 bits included in the bitmap and access type schedule field 850 of FIG. 8 may be configured as any one of encoding values of Table 1 below.

TABLE 1
Operation between AP or PCP DMG STA and
non-AP and PCP DMG STA during TDD slot

| | Behavior of AP | Behavior of Non-AP |
|---|---|---|
| Encoding | and PCP STA | and non-PCP STA |
| 0 | N/A:TDD slog unassigned | |
| 1 | TX | RX |
| 2 | RX | TX |

| | |
|---|---|
| 3 | Unavailable |

As an example, when the consecutive 2 bits included in the bitmap and access type schedule field 850 of Table 1 above indicate ‘0’, a wireless terminal may understand a corresponding TDD slot as a TDD slot unassigned to the wireless terminal.

As an example, when the consecutive 2 bits included in the bitmap and access type schedule field 850 of Table 1 above indicate ‘1’, a wireless terminal corresponding to a non-AP STA (or non-PCP STA) may understand a corresponding TDD slot as a TDD slot in which a reception operation is permitted.

As another example, when the consecutive 2 bits included in the bitmap and access type schedule field 850 of Table 1 above indicate ‘1’, a wireless terminal corresponding to an AP STA (or PCP STA) may understand a corresponding TDD slot as a TDD slot in which a transmission operation is permitted.

As an example, when the consecutive 2 bits included in the bitmap and access type schedule field 850 of Table 1 above indicate ‘2’, a wireless terminal corresponding to a non-AP STA (or non-PCP STA) may understand a corresponding TDD slot as a TDD slot in which a transmission operation is permitted.

As another example, when the consecutive 2 bits included in the bitmap and access type schedule field 850 of Table 1 above indicate ‘2’, a wireless terminal corresponding to an AP STA (or PCP STA) may understand a corresponding TDD slot as a TDD slot in which a reception operation is permitted.

As an example, when the consecutive 2 bits included in the bitmap and access type schedule field 850 of Table 1 above indicate ‘3’, a wireless terminal may understand a corresponding TDD slot as an unavailable TDD slot.

For example, bitmap information included in bitmap and access type schedule field 850 may be repeated for a predetermined time period.

A slot category schedule filed 860 of FIG. 8 may be associated with category information of each of multiple TDD slots included in at least one TDD interval during which the TDD slot schedule element 800 is applied.

Here, the slot category schedule filed 860 of FIG. 8 may be bitmap information having a length which is determined based on Equation 1 above.

Particularly, each pair of consecutive 2 bits included in the slot category schedule filed 860 of FIG. 8 may corresponding to each pair of consecutive 2 bits included in the bitmap and access type schedule field 850.

In addition, each pair of consecutive 2 bits included in the slot category schedule filed 860 of FIG. 8 may indicate a type of allowed frame in a corresponding TDD slot.

For example, when 2 bits included in the slot category schedule filed 860 of FIG. 8 indicates ‘0’, a corresponding TDD slot may be understood as a Basic TDD slot. In other words, in the Basic TDD slot, all types of frames may be transmitted.

For example, when 2 bits included in the slot category schedule filed 860 of FIG. 8 indicates ‘0’, a corresponding TDD slot may be understood as a Data-only TDD slot. In other words, only data frame may be transmitted in the Data-only TDD slot.

FIG. 9 is a diagram illustrating a format of a control field of a TDD slot schedule element.

Referring to FIG. 4 to FIG. 9, slot schedule control fields 840 and 900 for the TDD slot schedule element 800 may include multiple sub-fields 910 to 970.

A channel aggregation sub-field 910 of FIG. 9 may include information for channel aggregation for a PPDU transmission.

A BW sub-field 920 of FIG. 9 may include information for channel bandwidth for a PPDU transmission may be included.

A slot schedule start time sub-field 930 of FIG. 9 may include information for lower 4 octets of a timing synchronization function (TSF) that corresponds to a start time of a first TDD interval (e.g., the start time of TDD interval 1 of FIG. 4) to which the TDD slot schedule element 800 for a wireless terminal is to be applied.

A sub-field for the number of TDD intervals in the bitmap 940 of FIG. 9 may include information for the number of at least one TDD interval after a start time indicated by the slot schedule start time sub-field 930 in a TDD SP.

An allocation ID sub-field 950 of FIG. 9 may include information for identifying a TDD SP (e.g., SP2 of FIG. 4) among the information included in the Extended schedule element that defines a schedule of a DTI of a beacon interval.

A TDD slot schedule duration sub-field 960 of FIG. 9 may include information associated with a duration for applying the TDD slot schedule element 800.

For example, the wireless terminal receiving the power saving permission sub-field 960 set to ‘1’ may know that the power saving mode is permitted.

As another example, it can be seen that the wireless terminal receiving the power saving permission sub-field 960 set to ‘0’ is not permitted in the power saving mode (hereinafter, referred to as ‘PS mode’). In other words, the wireless terminal receiving the power saving permission sub-field 960 set to ‘0’ operates in an active mode.

For reference, the last bits B56 to B63 of the slot schedule control field 900 of FIG. 9 may be reserved.

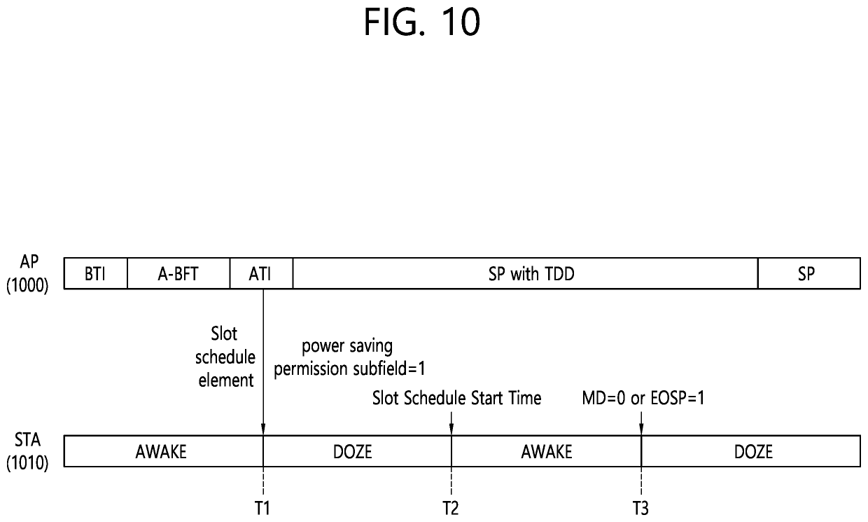

FIG. 10 is a diagram illustrating an operation of a wireless terminal supporting a power saving mode in a TDD SP in a wireless local area network (WLAN) system according to an embodiment of the present disclosure.

Referring to FIGS. 1 to 10, a horizontal axis t1 of an AP 1000 of FIG. 10 may be associated with time. Here, the horizontal axis t1 of the AP 1000 of FIG. 10 may be understood based on the description of the access period within the beacon interval of FIG. 3 and the TDD SP of FIG. 4 described above.

In addition, a horizontal axis t2 of the STA 1010 of FIG. 10 may be associated with time. A vertical axis of the STA 1010 may be associated with a state based on the PS mode of the STA 1010.

According to an embodiment of the present disclosure, the STA 1010 may maintain the awake state until a slot schedule element is received from the AP 1000 (i.e., before time T1). The STA 1010 may receive a slot schedule element from the AP 1000 at time T1 of FIG. 10.

For reference, although the slot schedule element of FIG. 10 is shown to be received by the STA 1010 in the ATI, it will be understood that the present disclosure is not limited thereto.

According to an embodiment of the present disclosure, the slot schedule element of FIG. 10 may be understood based on the description of FIGS. 8 and 9 described above.

For example, the slot schedule start time sub-field (e.g., 930 of FIG. 9) included in the slot schedule element of FIG. 10 may include information associated with the slot schedule start time for the STA 1010.

Specifically, the information associated with the slot schedule start time for the STA 1010 may be associated with lower 4 octets of a timing synchronization function (TSF) timer corresponding to a start time of a first TDD interval (e.g., start time of TDD interval 1 of FIG. 4) to which the TDD slot schedule element (e.g., 800 in FIG. 8) for the STA 1010 is to be applied.

In addition, the power saving permission sub-field (e.g., 960 of FIG. 9) included in the slot schedule element of FIG. 10 may include information associated with whether the PS mode is permitted for the STA 1010 receiving the TDD slot schedule element.

For example, the STA 1010 that has received the slot schedule element including the power saving permission sub-field (e.g., 960 in FIG. 9) set to ‘1’ as shown in FIG. 10 may know that the PS mode is permitted to itself.

Upon receiving the slot schedule element of FIG. 10, the STA 1010 may switch from the awake state to the doze state based on the PS mode.

Subsequently, the STA 1010 according to an embodiment of the present disclosure may maintain the doze state from the time point T1 at which the slot schedule element of FIG. 10 is received to a time point T2 before slot schedule start time included in the slot schedule element.

Subsequently, the STA 1010 according to an embodiment of the present disclosure may switch from the doze state to the awake state at the time point T2 when the slot schedule start time elapses.

In addition, the STA 1010 according to an embodiment of the present disclosure may maintain the awake state from the time point T2 at which the slot schedule start time elapses to a time point T3 when a last downlink frame is received in the current TDD SP and perform communication based on TDD scheduling with the AP 1000.

According to an embodiment of the present disclosure, whether the downlink frame transmitted by the AP 1000 corresponds to the last downlink frame in the current TDD SP may be indicated based on a more data (MD) field or an end of service period (EOSP).

For example, when the MD field is set to ‘1’, the downlink frame transmitted by the AP 1000 may correspond to the last downlink frame in the current TDD SP. As another example, when the EOSP field is set to ‘1’, the downlink frame transmitted by the AP 1000 may correspond to the last downlink frame in the current TDD SP.

Referring to FIG. 10, when the downlink frame transmitted by the AP 1000 at a specific time point T3 of FIG. 10 is determined to be the last downlink frame in the current TDD SP, the STA 1010 may be switched from the awake state to the doze state.

Subsequently, the STA 1010 may maintain the doze state during a remaining period of the current TDD SP. Further, the STA 1010 may maintain the doze state until a next BTI or a next TDD scheduling start time.

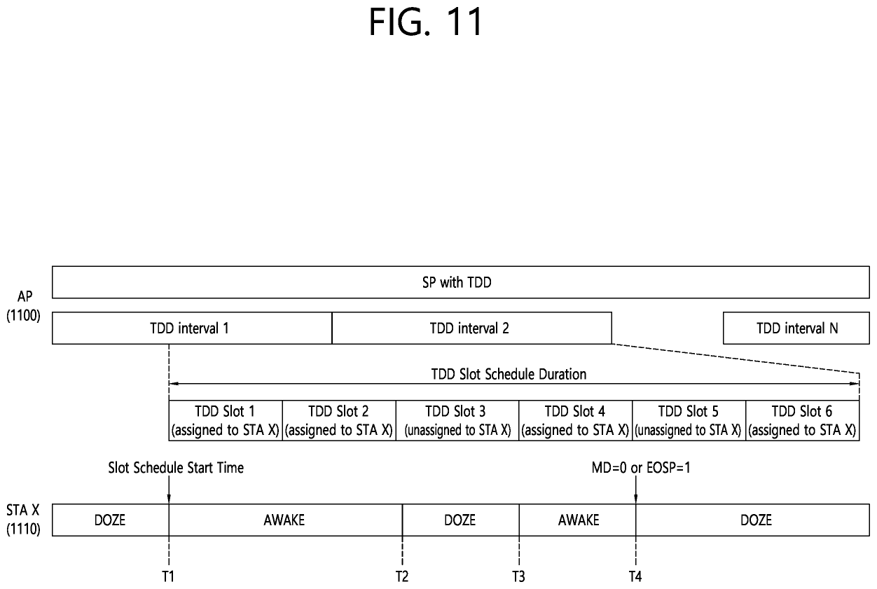

FIG. 11 is a diagram illustrating an operation of a wireless terminal supporting a power saving mode in a TDD SP in a wireless local area network (WLAN) system according to an embodiment of the present disclosure.

Referring to FIGS. 1 to 11, a horizontal axis of an AP 1100 may represent time associated with a plurality of TDD intervals TDD interval 1 to TDD interval N.

Referring to FIG. 11, the TDD slot schedule duration in which the slot schedule element is effective may be a time period from a slot schedule start time T1 within the first TDD interval (TDD interval 1) to an end time T4 of a second TDD interval (TDD interval 2).

The TDD slot schedule duration T1 to T4 of FIG. 11 may include first to sixth TDD slots (TDD slot 1 to TDD slot 6).

For example, the first and second TDD slots (TDD slot 1, TDD slot 2) may be allocated to the STA 1110. In addition, a third TDD slot (TDD slot 3) may not be allocated to the STA 1110. Further, the fourth to sixth TDD slots (TDD slots 4 to 6) may be allocated to the STA 1110.

The STA 1110 according to an embodiment of FIG. 11 may perform an operation according to the PS mode based on a TDD slot unit. For example, before the first time point T1, the STA 1110 may be in a doze state. When the slot schedule start time T1 elapses, the STA 1110 may switch from the doze state to the awake state.

Subsequently, the STA 1110 may maintain the awake state during a first period (T1 to T2) associated with the first and second TDD slots (TDD slot 1 to TDD slot 2) allocated for the STA 1110. For example, the STA 1110 may communicate with the AP 1100 according to TDD scheduling during the first period T1 to T2. When the first period T1 to T2 elapses, the STA 1110 may switch from the awake state to the doze state.

Subsequently, the STA 1110 may maintain the doze state during the second period (T2 to T3) associated with the third slot (TDD slot 3) which is not allocated for the STA 1110. When the second period (T2 to T3) elapses, the STA 1110 may switch from the doze state to the awake state.

Subsequently, the STA 1110 may maintain the awake state during the third period (T3 to T4) associated with the fourth TDD slot 4 allocated for the STA 1110. For example, the STA 1110 may communicate with the AP 1100 according to TDD scheduling during the third period (T3 to T4).

According to the embodiment of FIG. 11, in the third period (T3 to T4), whether the corresponding downlink frame is the last frame in the current TDD SP may be indicated through the MD field or the EOSP field of the downlink frame received by the STA 1110. In this case, the STA 1110 may switch from the awake state to the doze state.

Subsequently, when the corresponding downlink frame is indicated as the last frame in the current TDD SP, the STA 1110 may maintain the doze state during a remaining TDD SP period (i.e., TDD slot 5 and TDD slot 6 in FIG. 11). In this case, the remaining TDD SP period (i.e., TDD slot 5 and TDD slot 6 in FIG. 11) may be irrelevant to whether or not a TDD slot is allocated to the STA 1110.

As in the embodiment of FIG. 11, when the PS operation of the wireless terminal is performed in units of TDD slots, the wireless terminal may maintain the doze state in all TDD slots unallocated to itself, and thus, improved performance may be provided in terms of power management of the wireless terminal. As an additional option, the wireless terminal may be in the doze state in an RX slot.

However, it will be understood that the embodiment of FIG. 11 is only an example and the present disclosure is not limited thereto. For example, the STA may perform an operation according to the PS mode based on TDD interval units. The STA whose operation according to the PS mode is implemented based on the TDD interval units may have low implementation complexity but may have relatively low power efficiency according to the PS mode.

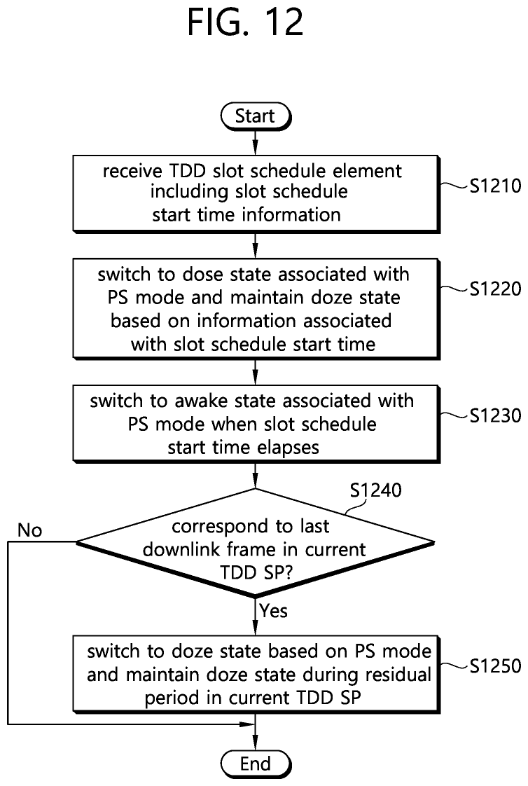

FIG. 12 is a flowchart illustrating a method of supporting a power saving mode in a TDD SP in a wireless local area network (WLAN) system according to an embodiment of the present disclosure from an STA perspective.

Referring to FIGS. 1 to 12, a first wireless terminal mentioned in FIG. 12 may correspond to the STA (e.g., 1010 or 1110), and a second wireless terminal mentioned in FIG. 12 may correspond to the AP (e.g., 1000 or 1100).

In step S1210, the first wireless terminal may receive a TDD slot schedule element from the second wireless terminal. The TDD slot schedule element according to an embodiment of the present disclosure may be understood based on the contents described in FIGS. 8 and 9 above.

For example, the TDD slot schedule element may include first information used to permit the PS mode to the first wireless terminal and second information associated with a slot schedule start time for the first wireless terminal.

For example, the TDD slot schedule element may be received in a management access period (e.g., announcement transmission interval (ATI) of FIG. 4) between the second wireless terminal and the first wireless terminal before the current TDD SP.

For example, when the TDD slot schedule element is received in the management access period, the first wireless terminal may be in the awake state.

In step S1220, when the TDD slot schedule element is received by the first wireless terminal, the first wireless terminal may switch to the doze state associated with the PS mode based on the first information. Also, the first wireless terminal may maintain the doze state until the slot schedule start time elapses based on the second information.

In step S1230, when the slot schedule start time elapses, the first wireless terminal may switch from the doze state to the awake state associated with the PS mode.

In step S1240, the first wireless terminal in the awake state may receive a downlink frame (i.e., PPDU) based on the TDD schedule from the second wireless terminal in the current TDD SP.

According to an embodiment of the present disclosure, the first wireless terminal may determine whether the received downlink frame corresponds to a last downlink frame allocated for the first wireless terminal in the current TDD SP.

For example, whether the received downlink frame is the last frame allocated for the first wireless terminal in the current TDD SP may be associated with the MD field or the EOSP field included in the received downlink frame.

If the received downlink frame does not correspond to the last downlink frame allocated for the first wireless terminal in the current TDD SP, the procedure may be terminated. In this case, the first wireless terminal may continue to communicate with the second wireless terminal based on the TDD schedule.

If the received downlink frame corresponds to the last downlink frame allocated for the first wireless terminal in the current TDD SP, the procedure proceeds to step S1250.

In step S1250, the first wireless terminal may switch from the awake state to the doze state. In addition, the first wireless terminal may maintain the doze state for a remaining period in the current TDD SP.

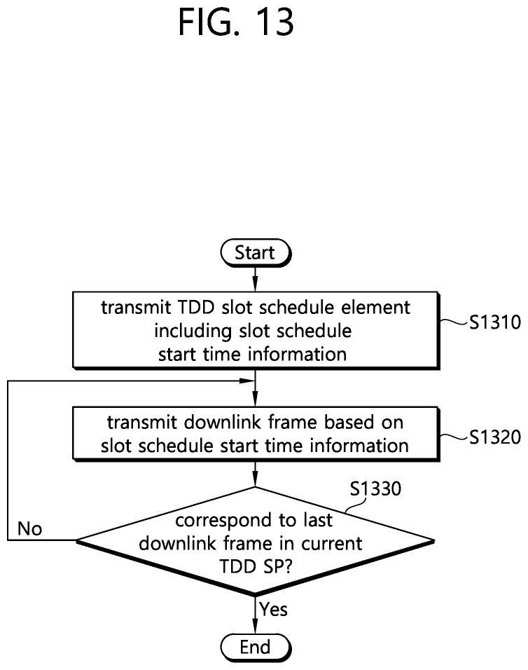

FIG. 13 is a flowchart illustrating a method of supporting a power saving mode in a TDD SP in a wireless local area network (WLAN) system according to an embodiment of the present disclosure from an AP perspective.

Referring to FIGS. 1 to 13, a first wireless terminal mentioned in FIG. 13 may correspond to the STA (e.g., 1010 or 1110), and a second wireless terminal mentioned in FIG. 13 may correspond to the AP (e.g., 1000 or 1100).

In step S1310, the second wireless terminal may transmit a TDD slot schedule element to the first wireless terminal. The TDD slot schedule element according to an embodiment of the present disclosure may be understood based on the contents described in FIGS. 8 and 9 above.

For example, the TDD slot schedule element may include first information used to permit the PS mode to the first wireless terminal and second information associated with a slot schedule start time for the first wireless terminal.

For example, the TDD slot schedule element may be transmitted in a management access period (e.g., announcement transmission interval (ATI) of FIG. 4) between the second wireless terminal and the first wireless terminal before the current TDD SP.

In step S1320, the second wireless terminal may transmit a downlink frame (i.e., PPDU) to the first wireless terminal based on the second information associated with the slot schedule start time.

In step S1330, the second wireless terminal may determine whether the downlink frame transmitted to the first wireless terminal corresponds to a last downlink frame in the current TDD SP.

If the downlink frame transmitted to the first wireless terminal corresponds to the last downlink frame in the current TDD SP, the procedure may be terminated. If the downlink frame transmitted to the first wireless terminal is not the last downlink frame in the current TDD SP, the procedure proceeds to step S1320 again.

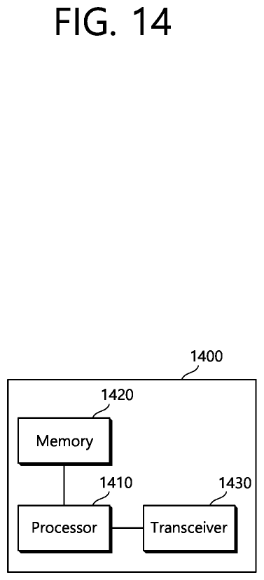

FIG. 14 is a block diagram illustrating a wireless device to which the embodiment may be applied.

Referring to FIG. 14, a wireless device may be an STA that may implement the embodiment described above and operated as an AP or a non-AP STA. In addition, the wireless device may correspond to a user described above or a transmission terminal that transmits a signal to a user.

The wireless device of FIG. 14 includes a processor 1410, a memory 1420 and a transceiver 1430 as shown in the drawing. The processor 1410, the memory 1420 and the transceiver 1430 may be implemented with a separate chip, or at least two or more blocks/functions may be implemented with a single chip.

The transceiver 1430 is a device including a transmitter and a receiver. In the case that a specific operation is performed, either one operation of the transmitter or receiver may be performed, or both the operations of the transmitter and receiver may be performed.

The transceiver 1430 may include one or more antennas that transmit and/or receive a wireless signal. In addition, the transceiver 1430 may include an amplifier for amplifying a reception signal and/or a transmission signal and a band pass filter for transmitting on a specific frequency band.

The processor 1410 may implement the proposed function, procedure and/or method proposed in the present disclosure. For example, the processor 1410 may perform the operation according to the embodiment described above. That is, the processor 1410 may perform the operation described in the embodiments of FIG. 1 to FIG. 13.

The processor 1410 may include an application-specific integrated circuit (ASIC), other chipset, a logical circuit, a data processing device and/or a transformer that transforms a baseband signal and a wireless signal with each other.

The memory 1420 may include read-only memory (ROM), random access memory (RAM), flash memory, memory card, storage medium and/or other storage device.

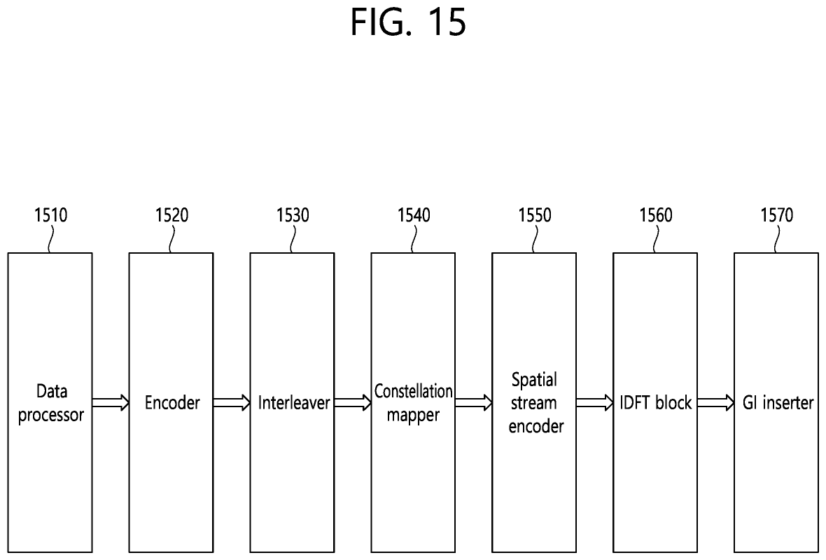

FIG. 15 is a block diagram illustrating an example of a device included in a processor.

For the convenience of description, an example of FIG. 15 is described based on a block for a transmission signal, but it is apparent that a reception signal may be processed using the corresponding block.

A data processor 1510, which is shown, generates transmission data (control data and/or user data) corresponding to a transmission signal. An output of the data processor 1510 may be input to an encoder 1520. The encoder 1520 may perform coding using BCC (binary convolutional code) or LDPC (low-density parity-check) technique. At least one encoder 1520 may be included, and the number of encoders 1520 may be determined by various types of information (e.g., the number of data streams).

An output of the encoder 1520 may be input to an interleaver 1530. The interleaver 1530 performs an operation of distributing consecutive bit signals on a radio resource (e.g., time and/or frequency) to prevent a burst error owing to fading. At least one interleaver 1530 may be included, and the number of interleavers 1530 may be determined by various types of information (e.g., the number of spatial streams).

An output of the interleaver 1530 may be input to a constellation mapper 1540. The constellation mapper 1540 may perform a constellation mapping such as BPSK (bi-phase shift keying), QPSK (Quadrature Phase Shift Keying), n-QAM (quadrature amplitude modulation), and the like.

An output of the constellation mapper 1540 may be input to a spatial stream encoder 1550. The spatial stream encoder 1550 performs a data processing for transmitting a transmission signal through at least one spatial stream. For example, the spatial stream encoder 1550 may perform at least one of STBC (space-time block coding), CSD (Cyclic shift diversity) insertion and spatial mapping.

An output of the spatial stream encoder 1550 may be input to an IDFT 1560. The IDFT 1560 block performs IDFT (inverse discrete Fourier transform) or IFFT (inverse Fast Fourier transform).

An output of the IDFT 1560 is input to a GI (Guard Interval) inserter 1570, and an output of the GI inserter 1570 is input to the transceiver 1430 of FIG. 14.

In the detailed description of the present disclosure, a specific embodiment is described. However, the specific embodiment may be modified in various manners within the scope which is not departing from the scope of the present disclosure. Therefore, the scope of the present disclosure should not be determined limitedly to the embodiment described above but determined by the claims described below and the equivalents of the claims of the present disclosure.

1. A method for supporting a power saving (PS) mode in a time division duplex service period (TDD SP) in a wireless local area network (WLAN) system, the method comprising:
receiving, by a first wireless terminal in an awake state, a downlink frame from a second wireless terminal in the TDD SP;
switching, by the first wireless terminal, from the awake state to a doze state when an end of service period (EOSP) field of the downlink frame is set to 1; and
maintaining, by the first wireless terminal, the doze state during a residual period of the TDD SP,
wherein the awake state and the doze state are associated with the PS mode.

2. The method of claim 1, further comprising:
determining, by the first wireless terminal, whether the downlink frame is a last downlink frame allocated for the first wireless terminal in the TDD SP based on the EOSP field;
receiving, by the first wireless terminal, a TDD slot schedule element from the second wireless terminal, the TDD slot schedule element including first information used to permit the PS mode to the first wireless terminal and second information associated with a slot schedule start time for the first wireless terminal;
switching, by the first wireless terminal, to the doze state based on the first information after the TDD slot schedule element is received by the first wireless terminal;
maintaining, by the first wireless terminal, the doze state until the slot schedule start time elapses based on the second information; and
switching, by the first wireless terminal, from the doze state to the awake state when the slot schedule start time elapses.

3. The method of claim 2, wherein whether the downlink frame is the last downlink frame allocated for the first wireless terminal in the TDD SP is associated with a more data (MD) field included in the downlink frame.

4. The method of claim 2, wherein the TDD slot schedule element is received in a management access period between the second wireless terminal and the first wireless terminal before the TDD SP, and the first wireless terminal is in the awake state when the TDD slot schedule element is received in the management access period.

5. The method of claim 4, wherein the management access period is associated with an announcement transmission interval (ATI).

6. A first wireless terminal supporting a power saving (PS) mode in a time division duplex service period (TDD SP) in a wireless local area network (WLAN) system, the first wireless terminal comprising:
a transceiver transmitting or receiving a wireless signal; and
a processor controlling the transceiver,
wherein the processor is configured to:
receive a downlink frame from a second wireless terminal in the TDD SP in an awake state;
switch from the awake state to a doze state when an end of service period (EOSP) field of the downlink frame is set to 1; and
maintain the doze state during a residual period of the TDD SP,
wherein the awake state and the doze state are associated with the PS mode.

7. The first wireless terminal of claim 6, wherein the processor is further configured to:
determine whether the downlink frame is a last downlink frame allocated for the first wireless terminal in the TDD SP based on the EOSP field;
receive a TDD slot schedule element from the second wireless terminal, the TDD slot schedule element including first information used to permit the PS mode to the first wireless terminal and second information associated with a slot schedule start time for the first wireless terminal;
switch to the doze state based on the first information after the TDD slot schedule element is received by the first wireless terminal;
maintain the doze state until the slot schedule start time elapses based on the second information; and
switch from the doze state to the awake state when the slot schedule start time elapses.

8. The first wireless terminal of claim 7, wherein whether the downlink frame is the last downlink frame allocated for the first wireless terminal in the TDD SP is associated with a more data (MD) field included in the downlink frame.

9. The first wireless terminal of claim 7, wherein the TDD slot schedule element is received in a management access period between the second wireless terminal and the first wireless terminal before the TDD SP, and
the first wireless terminal is in the awake state when the TDD slot schedule element is received in the management access period.

10. The first wireless terminal of claim 9, wherein the management access period is associated with an announcement transmission interval (ATI).
